(19) United States
(12) Patent Application Publication
(10) Pub. No.: US 2013/0055887 A1
(43) Pub. Date: Mar. 7, 2013

(54) MULTIPLE VALVE HEAD COMPRESSOR APPARATUS

(71) Applicants: Kevin Kroupa, St. Louis, MO (US); Steve Palmer, St. Louis, MO (US)

(72) Inventors: Kevin Kroupa, St. Louis, MO (US); Steve Palmer, St. Louis, MO (US)

(73) Assignee: ALLIED HEALTHCARE PRODUCTS INC., St. Louis, MO (US)

(21) Appl. No.: 13/224,882

(22) Filed: Sep. 2, 2011

(51) Int. Cl. F01B 31/00; B23P 15/00

(52) U.S. Cl. 91/468; 91/471; 29/888.02

(57) ABSTRACT

A multiple valve compressor head having a casing defining an intake chamber in selective communication with a cavity through a plurality of one-way intake valves and an exhaust chamber in selective communication with the cavity through a plurality of one-way exhaust valves is disclosed. The casing further defines an inlet port for the entry of gas into the intake chamber and an outlet port for forcing out compressed gas from the exhaust chamber. In operation, the multiple valve compressor head is in operative engagement with a reciprocating diaphragm that draws the gas into the intake chamber and then the cavity during the intake stroke of the diaphragm, while expelling compressed gas from the cavity and through the outlet port during the exhaust stroke of the diaphragm.

### FIELD

This document relates to a multiple valve head, and in particular a multiple valve head for a compressor apparatus used with a ventilator system.

### BACKGROUND

In medicine, mechanical ventilation is a method to mechanically assist or replace spontaneous breathing of a patient using a machine called a ventilator. The ventilator may include a compressor apparatus that draws in gas and delivers the compressed gas to the patient in a controlled manner to meet patient specifications. Specifically, the compressor apparatus may include one or more heads for drawing in gas for compression by a diaphragm driven against the cavity of the head in a reciprocating motion for generating compressed gas for delivery to the patient. As shown in FIGS. 1A and 1B, a prior art compressor head 10 used with a compressor apparatus (not shown) for generating compressed gas may include a body 12 defining an intake chamber 14 for drawing in a gas, such as air, oxygen or a mixture of different gases, through an inlet port 18 in communication with the intake chamber 14. The intake chamber 14 is in selective communication with a cavity 19 defined on the opposite side of the body 12 through an intake valve 22. The cavity 18 further includes an exhaust valve 24 in communication with an exhaust chamber 16 defined adjacent the intake chamber 14 that allows compressed gas to exit through an outlet port 20 of the prior art compressor head 10 for delivery to the patient. As further shown, the intake valve 22 includes an open intake side 26 having a plurality of apertures 40 in communication with the intake chamber 14 and an exhaust side 32 having a flexible flapper 34 in communication with the cavity 19. Similarly, the exhaust valve 24 includes an open intake side 30 having a plurality of apertures 38 and an exhaust side 28 having a flexible flapper 36 in communication with the exhaust chamber 16. In this arrangement, a diaphragm (not shown) in communication with the cavity 19 is driven in a reciprocal motion to draw in gas through the intake valve 22 of the intake chamber 14 when the diaphragm moves away from the cavity 19 and then expel compressed gas from the cavity 19 through the exhaust valve 24 that exits the outlet port 20 when the diaphragm moves toward the cavity 19. As further shown, gas flow A in FIGS. 1A and 1B illustrates the flow of gas through the compressor apparatus head 10 as the gas enters the inlet port 18 and compressed gas exits through the outlet port 20.

Although the prior art compressor head having the single intake and exhaust valve arrangement for a compressor apparatus has proven satisfactory for its intended purpose, there is still a need for a compressor apparatus head that consumes less power while achieving greater power output.

### SUMMARY

In one embodiment, compressor head may include a body defining an intake chamber in selective fluid flow communication with an exhaust chamber through a cavity. A plurality of one-way intake valves are disposed between the intake chamber and the cavity for permitting one-way gas flow from the intake chamber to the cavity, while a plurality of one-way exhaust valves may be disposed between the exhaust chamber and the cavity for permitting one-way gas flow from the cavity to the exhaust chamber. An inlet port is in communication with the intake chamber for permitting the inflow of a fluid into the intake chamber and an outlet port in communication with the exhaust chamber for permitting the outflow of the compressed gas from the exhaust chamber.

In another embodiment, a compressor head may include a body defining an intake chamber in selective fluid flow communication with an exhaust chamber through a cavity. A pair of one-way intake valves is disposed between the intake chamber and the cavity for permitting one-way gas flow from the intake chamber to the cavity. In addition, a pair of one-way exhaust valves may be disposed between the exhaust chamber and the cavity for permitting one-way gas flow from the cavity to the exhaust chamber. An inlet port in communication with the intake chamber for permitting inflow of a gas into the intake chamber and an outlet port in communication with the exhaust chamber for permitting outflow of compressed gas from the exhaust chamber.

In yet another embodiment, a method for using a compressor head may include providing a compressor head having a body defining an intake chamber in selective fluid flow communication with an exhaust chamber through a cavity. A plurality of one-way intake valves may be disposed between the intake chamber and the cavity for permitting one-way gas flow from the intake chamber to the cavity, while a plurality of one-way exhaust valves may be disposed between the exhaust chamber and the cavity for permitting one-way gas flow from the cavity to the exhaust chamber. An inlet port is in communication with the intake chamber for permitting the inflow of a gas into the intake chamber and an outlet port is in communication with the exhaust chamber for permitting the outflow of a compressed gas from the exhaust chamber. In some embodiments, the method may further include drawing the gas into the inlet port, and then allowing the gas in a pressurized state to exit through the outlet port of the compressor head having a flow rate that ranges between 4 liters per minute to 90 liters per minute.

In a further embodiment, a method of manufacturing a multi-valve compressor head may include:
forming a casing having an intake chamber and an exhaust chamber;
forming an inlet port in communication with the intake chamber and an outlet port in communication with the exhaust chamber;
forming a pair of one-way exhaust valves between the intake chamber and the exhaust chamber; and
forming a pair of one-way exhaust valves between the intake chamber and the exhaust chamber.

Additional objectives, advantages and novel features will be set forth in the description which follows or will become apparent to those skilled in the art upon examination of the drawings and detailed description which follows.

### BRIEF DESCRIPTION OF THE DRAWINGS

FIGS. 1A and 1B are simplified illustrations showing a top side and a bottom side of a prior art valve compressor head for a compressor apparatus;

FIG. 2 is an elevated perspective view showing one embodiment of a multiple valve compressor head for a compressor apparatus;

FIG. 3 is an opposing elevated perspective view of the multiple valve compressor head for a compressor apparatus;

FIG. 4 is a top view of the multiple valve compressor head for a compressor apparatus;

FIG. 5 is a bottom view of the multiple valve compressor head for a compressor apparatus;

FIG. 6 is a side view of the multiple valve compressor head for a compressor apparatus;

FIG. 7 is an opposing side view of the multiple valve compressor head for a compressor apparatus;

FIG. 8 is a cross-sectional view of the multiple valve compressor head for a compressor apparatus taken along line 8-8 of FIG. 2;

FIG. 9 is a cross-sectional view of the multiple valve compressor head for a compressor apparatus taken along line 9-9 of FIG. 2;

FIG. 10 is a flow chart illustrating a method for manufacturing the multiple valve compressor head for a compressor apparatus; and

FIG. 11 is a flow chart illustrating a method for using the multiple valve compressor head.

Corresponding reference characters indicate corresponding elements among the view of the drawings. The headings used in the figures should not be interpreted to limit the scope of the claims.

### DETAILED DESCRIPTION

In medicine, mechanical ventilation is a method to mechanically assist or replace spontaneous breathing of a patient using a machine called a ventilator. The ventilator may include a compressor apparatus that draws in gas and then delivers a compressed gas to the patient in a controlled manner to meet patient specifications. Specifically, the compressor apparatus may include one or more heads for drawing in gas for compression by a diaphragm driven against the cavity of the head in a reciprocating motion for generating compressed gas for delivery to the patient through the ventilator. Each respective compressor head includes a single intake valve for permitting one-way fluid flow from an intake chamber into the cavity and a single exhaust valve for permitting one-way fluid flow from the cavity into an exhaust chamber for egress of the gas from the compressor head to the output of the ventilator. However, it has been found that the single intake and exhaust valve arrangement of the prior art compressor head limits the efficiency and total flow output of the ventilator.

In view of the above, embodiments of the multiple valve compressor head as set forth herein include particular components, properties and characteristics that address issues related to improving the efficiency and total flow output of a compressor head as described in greater detail below.

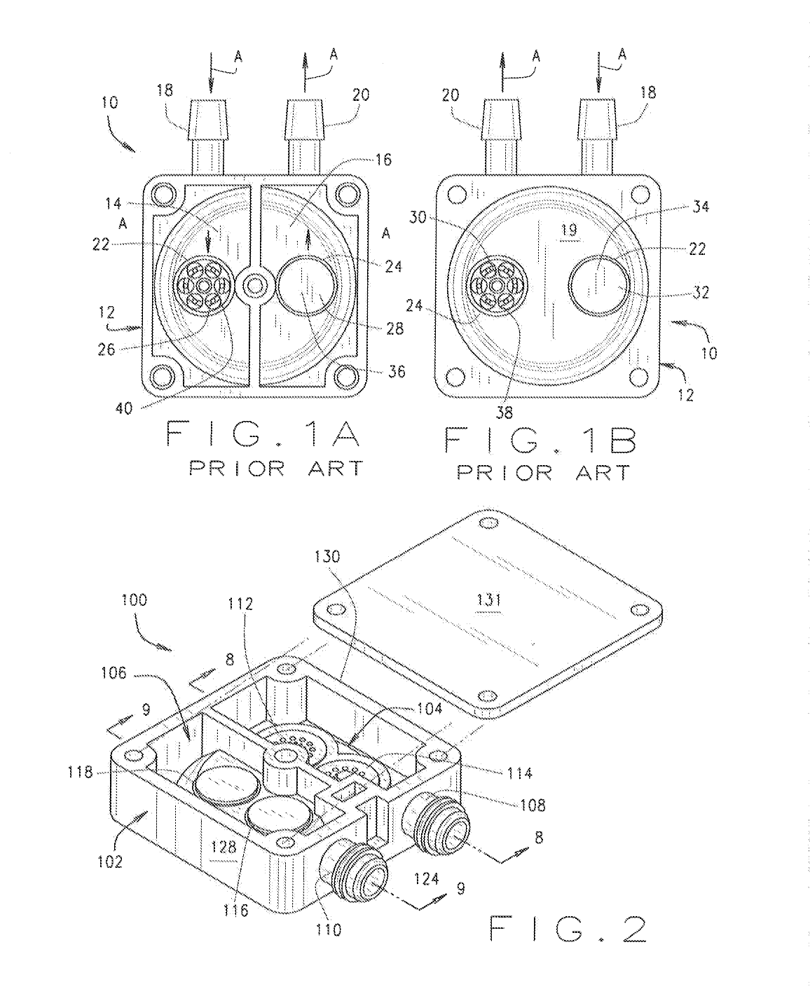

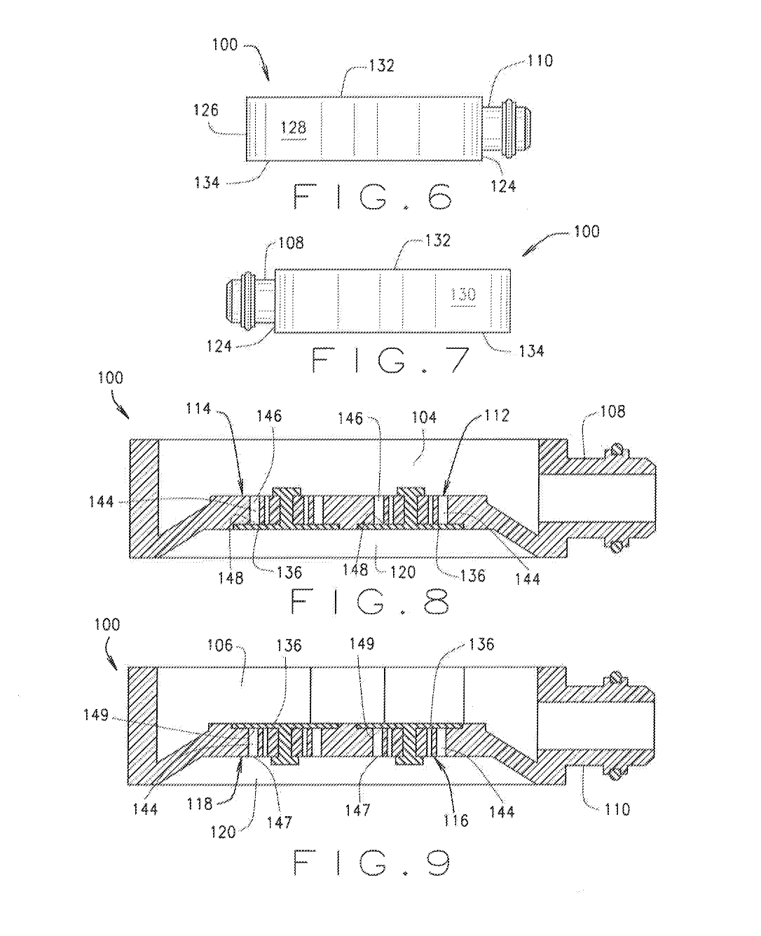

Referring to the drawings, various embodiments of the multiple valve compressor head are illustrated and generally indicated as 100 in FIGS. 1-9. In general, the multiple head compressor head 100 may include a casing 102 having an inlet port 108 in fluid flow communication with an intake chamber 104 for the inflow of gas into the multiple valve compressor head 100. A pair of intake valves 112 and 114 is disposed between the intake chamber 104 and a cavity 120 for permitting one-way flow of gas from the intake chamber 104 to the cavity 120. Moreover, a pair of exhaust valves 116 and 118 are disposed between the cavity 120 and an exhaust chamber 118 for permitting one-way flow of gas from the cavity 120 to the exhaust chamber 118. An outlet port 110 is in fluid flow communication with the exhaust chamber 118 to allow the outflow of gas from the multiple valve compressor head 100.

As further shown, the casing 102 of the multiple valve compressor head 100 may include a front side 124, a rear side 126, a left side 128, a right side 130, a top side 132, and a bottom side 134. Moreover, a front plate 131 may cover the top side 132 of the casing 102 while a rear plate 134 may cover the bottom side 133 of the casing 102. In some embodiments, the inlet port 108 and the outlet port 110 may extend outwardly from the front side 124; however, in other embodiments the inlet port 108 and outlet port 110 may extend from the rear side 126 of the casing 102. As further shown, the inlet port 108 includes a recess 121 configured to engage a sealing element 122, for example an O-ring, to provide a fluid-tight seal between the inlet port 108 and the connections (not shown) to the ventilator. Similarly, the outlet port 110 includes a recess 121 configured to engage a sealing element 122 to provide a fluid-tight seal between the outlet port 110 and the connections to the ventilator. In one embodiment, the casing 102 may be made from a metallic material, such as steel, aluminum, zinc, metallic composite brass, copper and combinations thereof, while in other embodiments the casing 102 may be made from a hard plastic material, such as polycarbonate, acrylonitrile butadiene styrene (ABS), polyethylene, polystyrene, polyvinyl chloride and polytetrafluoroethylene.

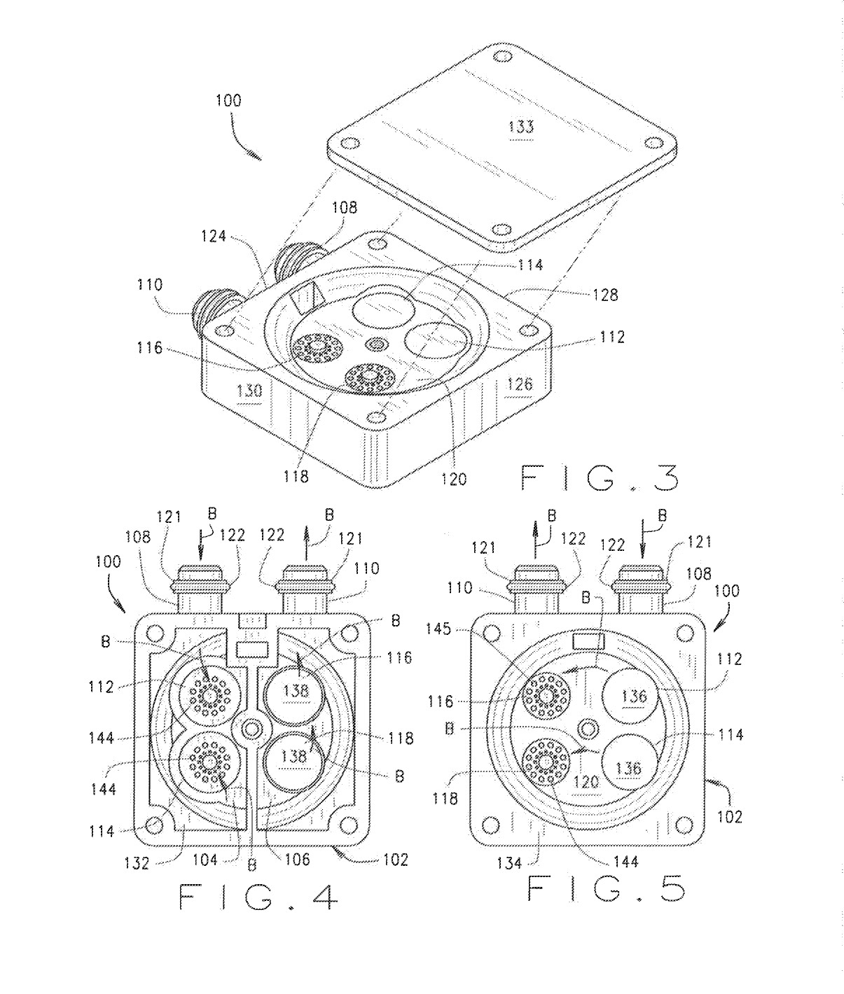

Referring specifically to FIG. 8, each of the intake valves 112 and 114 includes a respective plurality of conduits 144 each having a first open end 146 for permitting one-way entry of gas from the intake chamber 104 and a second open end 148 for permitting one-way exit of gas into the cavity 120 (FIG. 3). A flexible flapper portion 136 is operatively engaged with respective second open ends 148 of the plurality of conduits 144 that permits one-way gas flow from the intake chamber 104 to the cavity 120, but prevents opposing gas flow from the cavity 120 back into the intake chamber 104. In one embodiment, the center of each flapper portion 136 is secured to each respective intake valve 112 and 114 to permit the circumference of each flapper portion 136 to lift upwardly when gas is expelled from the intake chamber 104 and into the cavity 120. Conversely, the flapper portion 136 maintains a fluid tight seal against the plurality of conduits 144 to prevent the retrograde flow of gas from the cavity 120 back into the intake chamber 104.

Referring to FIG. 9, similar to intake valves 112 and 114, each of the exhaust valves 116 and 118 includes a respective plurality of conduits 145 each having a first open end 147 for permitting one-way entry of gas from the intake chamber 104 and a second open end 149 for permitting one-way exit of gas into the cavity 120. A respective flapper portion 138 is operatively engaged with a respective second open ends 149 of the plurality of conduits 145 that permit one-way gas flow from the cavity 120 to the exhaust chamber 106, but prevents retrograde gas flow from the exhaust chamber 106 back into the cavity 120. In one embodiment, the center of each flapper portion 138 is secured to each respective exhaust valve 116 and 118 to permit the circumference of each flapper portion 138 to lift upwardly when compressed gas is expelled from the cavity 120 and into the exhaust chamber 106. Conversely, the flapper portion 138 maintains a fluid tight seal against the plurality of conduits 145 to prevent the retrograde flow of gas from the exhaust chamber 106 back into the cavity 120.

In another embodiment, the intake valves 112 and 114 as well as the exhaust valves 116 and 118 may be include respective spring-loaded valves, rather than flapper portions 136 and 138, or other such mechanism that biases the intake valves 112 and 114 and exhaust valves 116 and 118 to a closed position to permit one-way flow.

Referring back to FIGS. 4 and 5, a flow of gas, designated gas flow B, illustrates the flow pathway of gas through the multiple valve compressor head 100. Specifically, gas flow B may enter the intake chamber 104 through inlet port 108 before entering each of the one-way intake valves 112 and 114 for entry into the cavity 120. Once inside the cavity 120, gas flow B is forced out into the exhaust chamber 106 through the pair of one-way exhaust valves 116 and 118 by the reciprocating action of the diaphragm (not shown). In one embodiment, the diaphragm may be operatively engaged to a piston that moves the diaphragm in a reciprocating action relative to the cavity 120. Movement of the reciprocating diaphragm away the cavity 120 during an intake stroke draws gas flow B from the intake chamber 104 and into the cavity 120 through intake valves 112 and 114, while movement of the diaphragm toward the cavity 120 during the exhaust stroke forces compressed gas from the cavity 120 and through the exhaust valves 116 and 118 such that the gas flow B enters the exhaust chamber 106. After entry into the exhaust chamber 104, gas flow B is forced out through the outlet port 110 for delivery to the patient through the ventilator at a flow rate in the range of 4-9 liters per minute.

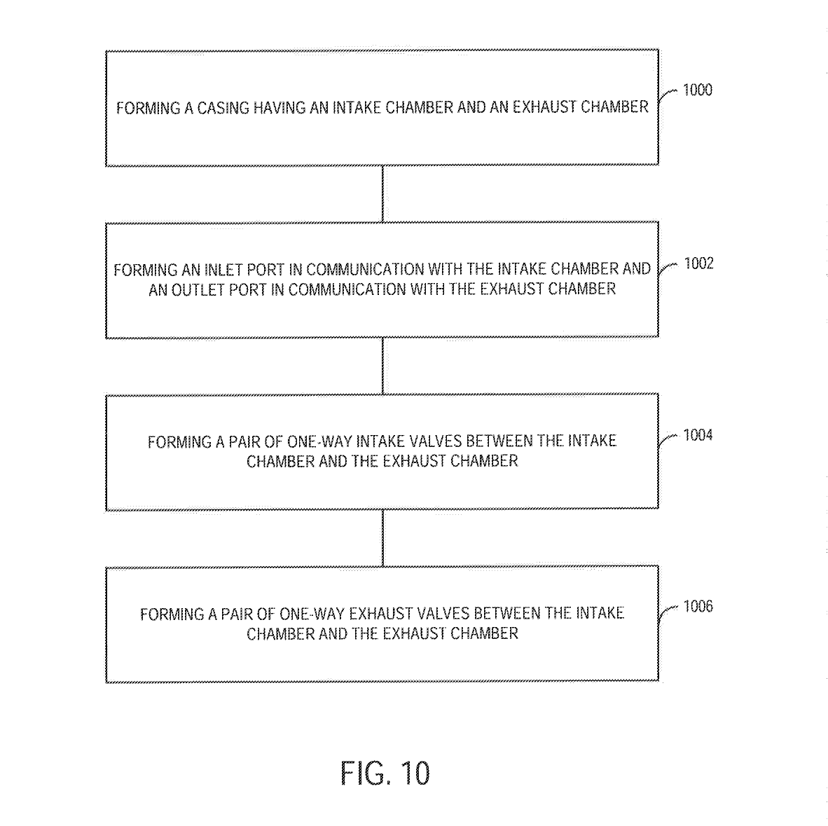

Referring to FIG. 10, a flow chart illustrates a method of manufacturing the multiple valve compressor head 100 as described above. At block 1000, forming a casing 102 having an intake chamber 104 and an exhaust chamber 118. At block 1002, forming an inlet port 108 in communication with the intake chamber 104 and forming an outlet port 110 in communication with the exhaust chamber 118. At block 1004, forming a pair of intake valves 112 and 114 between the intake chamber 104 and the exhaust chamber 118. At block 1006, forming a pair of exhaust valves 116 and 118 between the intake chamber 104 and the exhaust chamber 118. In some embodiments, the casing 102, intake chamber 104, exhaust chamber 118, inlet port 108 and outlet port 110 may be manufactured using a die-caste process, a molding process and/or a milling process.

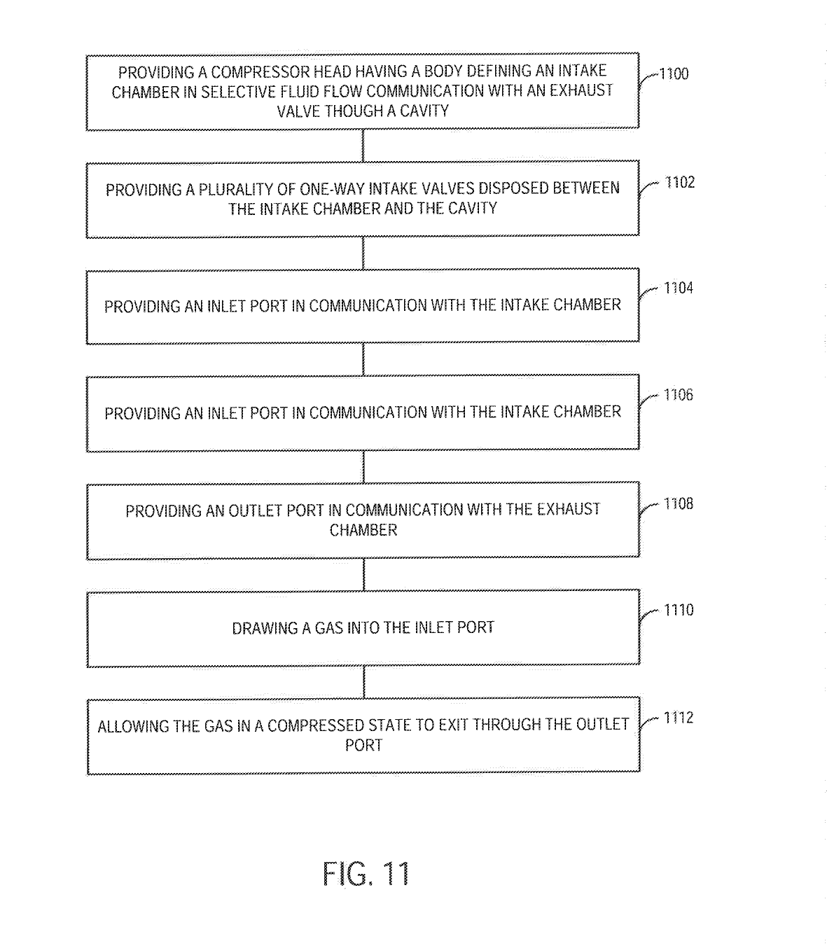

Referring to FIG. 11, a flow chart illustrates a method for operating the multiple valve compressor head 100 as described above. At block 1100, the multiple valve compressor head 100 having multiple intake valves 112 and 114 and multiple exhaust valves 116 and 118 is engaged to a ventilator. At block 1102, a gas is applied to the inlet port 108 of the multiple valve compressor head 100 and drawn into the intake chamber 104. At block 1104, the gas is drawn through the multiple intake valves 112 and 114 and into the cavity 120. At block 1106, the gas is compressed in the cavity 120. At block 1108, the compressed gas is forced through the multiple exhaust valves 116 and 118 and into the exhaust chamber 106 and then at block 1010 the compressed gas if then forced from the exhaust chamber 106 and through the outlet port 110.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

1. A compressor head comprising:
a body defining an intake chamber in selective fluid flow communication with an exhaust chamber through a cavity;
a plurality of one-way intake valves disposed between the intake chamber and the cavity for permitting one-way gas flow from the intake chamber to the cavity;
a plurality of one-way exhaust valves disposed between the exhaust chamber and the cavity for permitting one-way gas flow from the cavity to the exhaust chamber;
an inlet port in communication with the intake chamber for permitting the inflow of a gas into the intake chamber; and
an outlet port in communication with the exhaust chamber for permitting the outflow of a compressed gas from the exhaust chamber.

2. The compressor head of claim 1, wherein each of the plurality of one-way intake valves comprises:
a body defining a plurality of conduits having a first open end and a second open end, wherein the second open end is configured to be engaged to a flapper portion for preventing fluid flow communication in one direction and at least partially disengaged from the flapper portion for permitting fluid flow communication in an opposite direction.

3. The compressor head of claim 2, wherein fluid flow communication is permitted from the first open end to the second open end of the plurality of conduits.

4. The compressor head of claim 2, wherein fluid flow communication is prevented from the second open end to the first open end of the plurality of conduits by the flapper portion.

5. The compressor head of claim 1, wherein each of the plurality of one-way exhaust valves comprises:
a body defining a plurality of conduits having a first open end and a second open end, wherein the second open end is configured to be engaged to a biased closed valve for preventing fluid flow communication in one direction and at least partially disengaged from the biased closed valve for permitting fluid flow communication in an opposite direction.

6. The compressor head of claim 5, wherein fluid flow communication is permitted from the first open end to the second open end of the plurality of conduits.

7. The compressor head of claim 5, wherein fluid flow communication is prevented from the second open end to the first open end of the plurality of conduits by the biased closed valve.

8. The compressor head of claim 1, wherein the gas flow from the outlet port is in the range of 4 liters per minute to 90 liters per minute.

9. The compressor head of claim 2, wherein the plurality of intake valves are oriented such that the flapper portion engaged to each of the plurality of intake valves is in communication with the cavity.

10. The compressor head of claim 5, wherein the plurality of exhaust valves are oriented such that the flapper portion engaged to each of the plurality of exhaust valves is in communication with the exhaust chamber.

11. The compressor head of claim 1, wherein the outlet port includes a recess configured to engage a first sealing element.

12. The compressor head of claim 1, wherein the inlet port includes a recess configured to engage a second sealing element.

13. The compressor of claim 1, wherein the cavity is configured to engage a diaphragm for compressing the fluid.

14. The compressor head of claim 13, wherein the diaphragm moves in a reciprocating motion relative to the cavity for drawing in the fluid into the cavity from the intake chamber via the plurality of one-way intake valves.

15. The compressor head of claim 14, wherein the diaphragm moves in a reciprocating motion relative to the cavity to force the fluid into the exhaust chamber from the cavity via the plurality of one-way exhaust valve.

16. The compressor head comprising:
a body defining an intake chamber in selective fluid flow communication with an exhaust chamber through a cavity;
a pair of one-way intake valves disposed between the intake chamber and the cavity for permitting one-way gas flow from the intake chamber to the cavity;
a pair of one-way exhaust valves disposed between the exhaust chamber and the cavity for permitting one-way gas flow from the cavity to the exhaust chamber;
an inlet port in communication with the intake chamber for permitting inflow of a gas into the intake chamber; and
an outlet port in communication with the exhaust chamber for permitting outflow of a compressed gas from the exhaust chamber.

17. The compressor head of claim 16, wherein each of the pair of one-way intake valves comprises:
a body defining a plurality of conduits having a first open end and a second open end, wherein the second open end is configured to be engaged to a biased closed valve for preventing fluid flow communication in one direction and at least partially disengaged from the biased closed valve for permitting fluid flow communication in an opposite direction.

18. The compressor head of claim 16, wherein each of the pair of one-way exhaust valves comprises:
a body defining a plurality of conduits having a first open end and a second open end, wherein the second open end is configured to be engaged to a biased closed valve for preventing fluid flow communication in one direction and at least partially disengaged from the biased closed valves for permitting fluid flow communication in an opposite direction.

19. A method of using a compressor head comprising:
providing a compressor head comprising:
a body defining an intake chamber in selective fluid flow communication with an exhaust chamber through a cavity;
a plurality of one-way intake valves disposed between the intake chamber and the cavity for permitting one-way gas flow from the intake chamber to the cavity;
a plurality of one-way exhaust valves disposed between the exhaust chamber and the cavity for permitting one-way gas flow from the cavity to the exhaust chamber;
an inlet port in communication with the intake chamber for permitting the inflow of a gas into the intake chamber; and
an outlet port in communication with the exhaust chamber for permitting the outflow of a compressed gas from the exhaust chamber;
drawing a gas into the inlet port; and
allowing the gas in a compressed state to exit through the outlet port.

20. The method of claim 19, wherein a range of between 4 liters per minute to 90 liters per minute flows through the compressor head.

21. The method of claim 19, wherein the compressor head is in operative association with a reciprocating diaphragm that draws in the gas into the inlet port during an intake stroke of the diaphragm and allows the gas in a compressed state to exit the outlet port during an exhaust stroke of the diaphragm.

22. A method of manufacturing a compressor head comprising:
forming a casing having an intake chamber and an exhaust chamber;
forming an inlet port in communication with the intake chamber and an outlet port in communication with the exhaust chamber;
forming a pair of one-way exhaust valves between the intake chamber and the exhaust chamber; and
forming a pair of one-way exhaust valves between the intake chamber and the exhaust chamber.

23. The method of claim 22, wherein forming the casing comprises using at least one of a milling process, a molding process, and a die-caste process.
